(19) United States
(12) Patent Application Publication
(10) Pub. No.: US 2014/0095210 A1
(43) Pub. Date: Apr. 3, 2014

(54) COMPUTER-IMPLEMENTED METHOD AND SYSTEM FOR FACILITATING INFORMATION SHARING, COMMUNICATION, AND COLLABORATION IN A HEALTHCARE FACILITY

(71) Applicant: CareRev, Inc., Cape Elizabeth, ME (US)

(72) Inventor: Foster R. Goss, Cape Elizabeth, ME (US)

(73) Assignee: CareRev, Inc., Cape Elizabeth, ME (US)

(21) Appl. No.: 14/044,231

(22) Filed: Oct. 2, 2013

Related U.S. Application Data
(60) Provisional application No. 61/708,769, filed on Oct. 2, 2012.

(51) Int. Cl. G06F 19/00

(52) U.S. Cl. CPC G06F 19/322
USPC 705/3

(57) ABSTRACT

A computer-implemented method for facilitating information sharing, communication, and collaboration in a healthcare facility includes the steps of: (a) maintaining data in a computer storage system relating to each of a plurality of patients being treated at the healthcare facility, said data for each patient including information relating to medical care being provided to the patient in the healthcare facility, and information relating to a team of healthcare providers on-duty at the healthcare facility assigned to the patient; (b) providing access to the data relating to each patient to the patient and the team of healthcare providers assigned to the patient by transmitting information to client computer devices operated by the patient and the team of healthcare providers at the healthcare facility; (c) exchanging messages among patients and healthcare providers through their respective client computer devices; and (d) enabling each team of healthcare providers to coordinate and distribute tasks relating to the medical care provided to each patient.

### CROSS REFERENCE TO RELATED APPLICATION

This application claims priority from U.S. Provisional Patent Application No. 61/708,769 filed on Oct. 2, 2012 entitled IN-HOSPITAL INFORMATION, COMMUNICATION AND COLLABORATION SYSTEM, which is hereby incorporated by reference.

### BACKGROUND

The present application relates to an information, communication, and collaboration system for use by patients and healthcare providers (such as doctors and nurses) in a hospital or other healthcare facility.

### BRIEF SUMMARY OF THE DISCLOSURE

In accordance with one or more embodiments, a computer-implemented method is provided for facilitating information sharing, communication, and collaboration in a healthcare facility. The method includes the steps of: (a) maintaining data in a computer storage system relating to each of a plurality of patients being treated at the healthcare facility, said data for each patient including information relating to medical care being provided to the patient in the healthcare facility, and information relating to a team of healthcare providers at the healthcare facility assigned to the patient; (b) providing access to the data relating to each patient to the patient and the team of healthcare providers assigned to the patient by transmitting information to client computer devices operated by the patient and the team of healthcare providers at the healthcare facility; (c) exchanging messages among patients and healthcare providers through their respective client computer devices; and (d) enabling each team of healthcare providers to coordinate and distribute tasks relating to the medical care provided to each patient.

A computer system in accordance with one or more embodiments comprises at least one processor; memory associated with the at least one processor; and a program supported in the memory for facilitating information sharing, communication, and collaboration in a healthcare facility. The program contains a plurality of instructions which, when executed by the at least one processor, cause the at least one processor to: (a) maintain data in a computer storage system relating to each of a plurality of patients being treated at the healthcare facility, said data for each patient including (a) information relating to medical care being provided to the patient in the healthcare facility, and (b) information relating to a team of healthcare providers at the healthcare facility assigned to the patient; (b) provide access to the data relating to each patient to the patient and the team of healthcare providers assigned to the patient by transmitting information to client computer devices operated by the patient and the team of healthcare providers at the healthcare facility; (c) exchange messages among patients and healthcare providers through their respective client computer devices; and (d) enable each team of healthcare providers to coordinate and distribute tasks relating to the medical care provided to each patient.

### BRIEF DESCRIPTION OF THE DRAWINGS

FIG. 1 is a simplified block diagram illustrating a representative network in which a system in accordance with one or more embodiments can be implemented.

FIGS. 2-11B are exemplary screenshots illustrating features of the system in accordance with various embodiments.

### DETAILED DESCRIPTION

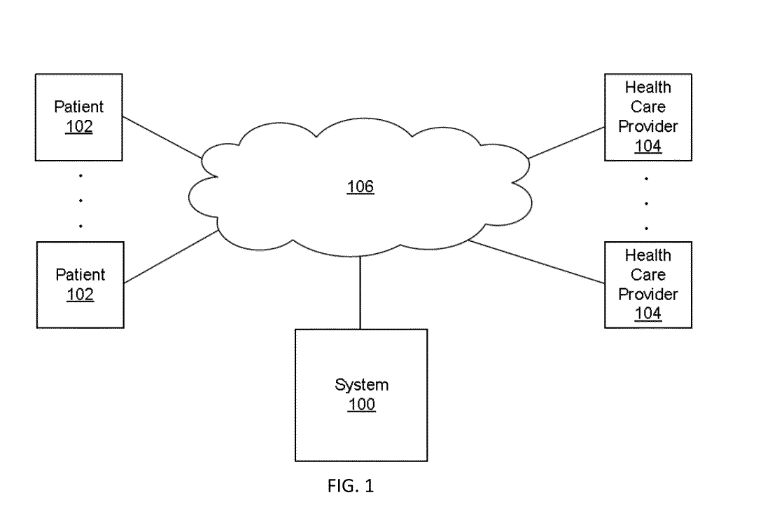

FIG. 1 illustrates an exemplary network, in which an information, communication, and collaboration system 100 in accordance with one or more embodiments may be implemented. The system 100 is preferably implemented in a computer server system, which communicates with a plurality of client devices operated by the users of the system 100, including patients 102 and care providers 104. The client devices communicate with the system 100 over a communications network 106. The communications network 106 may comprise any network or combination of networks including, without limitation, the Internet, a local area network, a wide area network, a wireless network, and a cellular network.

The client devices operated by users to access the system 100 can comprise any computing device that can communicate with the computer server system including, without limitation, personal computers (including desktop, notebook, and tablet computers), smart phones and other smart devices, and cell phones. In one exemplary embodiment, the patient and care provider client devices comprise portable smart phones or tablet computers running an iOS or Android application (or app) providing access to the system 100.

The computer server system is coupled to a computer storage system for storing data (discussed below) relating to the patients and care providers.

In accordance with one or more embodiments, the system features a real-time mobile communications platform that allows patients in the hospital or other facility to communicate with their healthcare providers using client devices. Patients can also use their client devices to view information on their medical conditions, treatment goals, test results, upcoming tests or evaluations, and post questions for their care-team on a whiteboard.

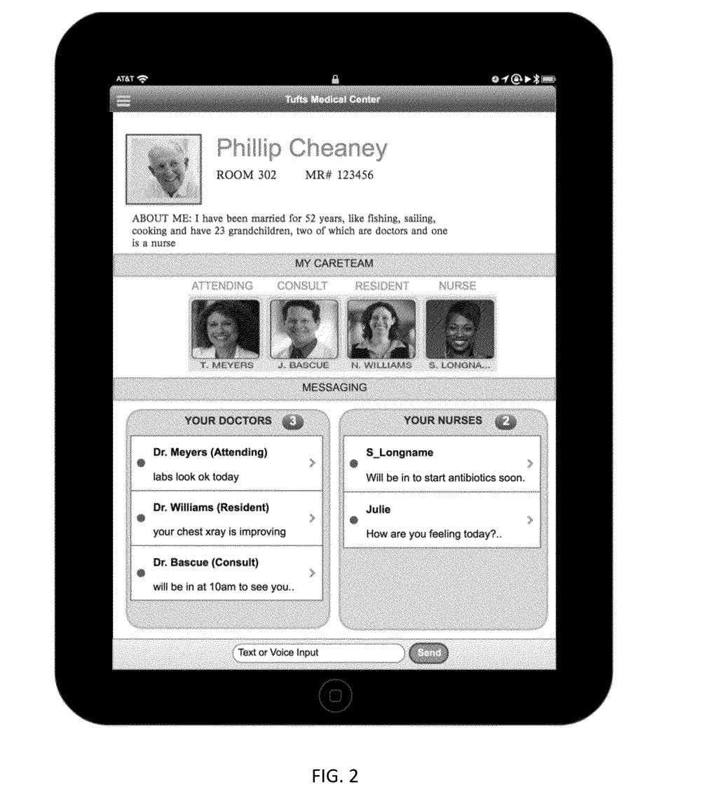

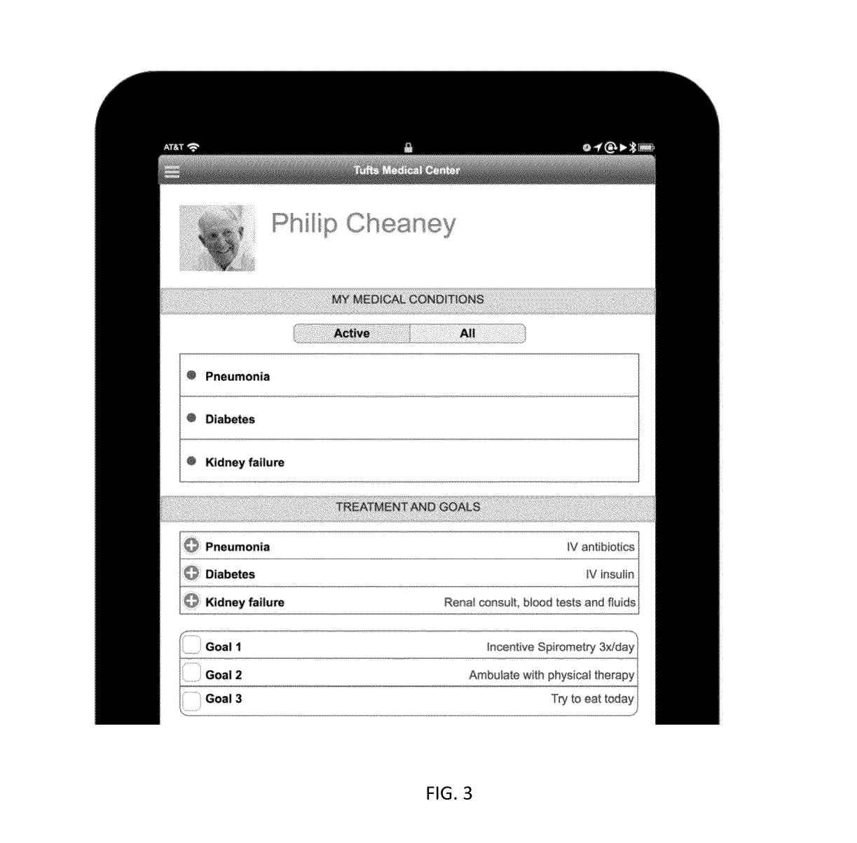

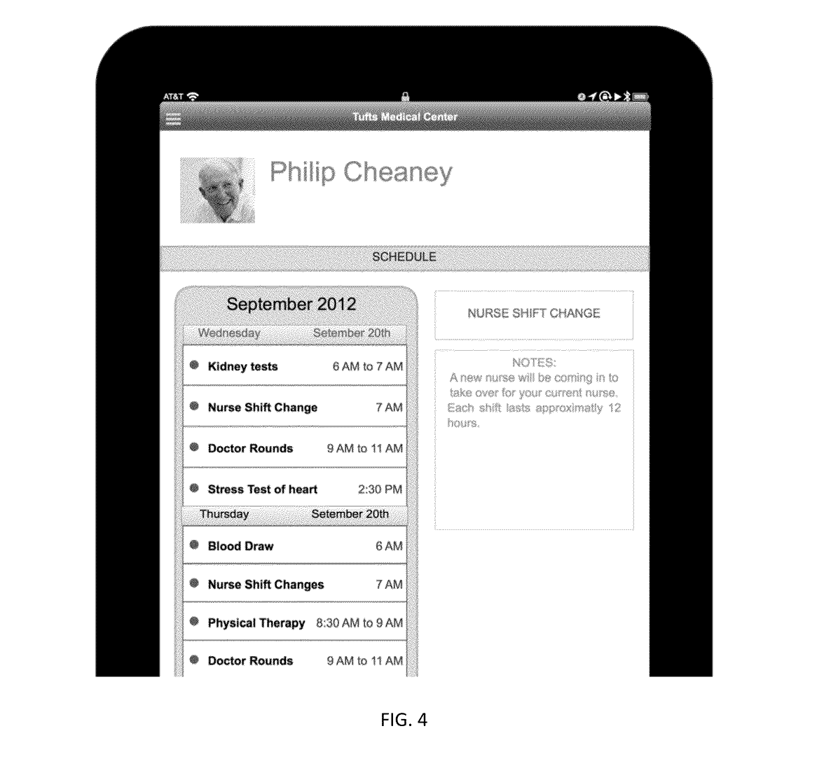

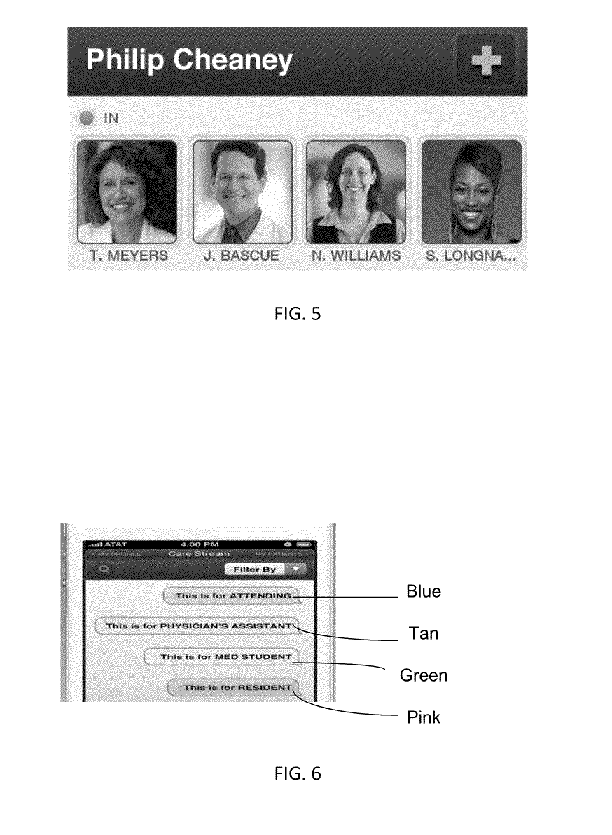

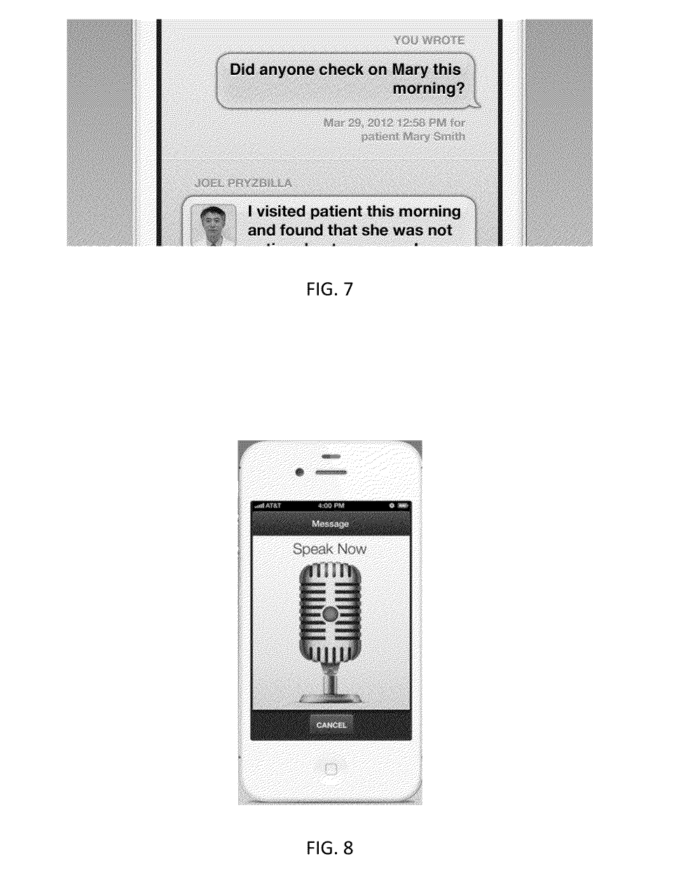

FIGS. 2-8 are non-limiting examples of screenshots showing information accessible to a patient on his or her client device. In this example, the information is organized into six sections: About Me, a short bio entered by the patient that the Care-team can see (FIG. 2), My Care-team (FIG. 2), Messaging/Whiteboard (FIG. 2), My Medical Conditions (FIG. 3), Treatment And Goals (FIG. 3), and Schedule (FIG. 4).

Communication

The system allows healthcare providers assigned to a patient to provide information to patients related to their care. The system stores information on each patient pertinent to their care, including information on tests, schedules, goals, and messages. Healthcare providers using their client devices can update such information. Healthcare providers can send the information to patients in various formats (or combinations thereof) including text, images (e.g., a chest x-ray), video, and recorded audio messages. Patients can communicate with healthcare providers (typically the nurse, but also doctors and other care providers) using their client devices through voice or text messaging as shown in FIG. 2 as well as post questions to their whiteboard with questions they have about their care. The client devices can include voice recognition capability to translate speech to text to make communication easier for users as shown in FIG. 8.

Care-Team

Patients can view on their client devices a list of the Care-team members currently on duty as shown in FIG. 2. The Care-team for a given patient comprises a particular group of doctors, nurses, and other care providers caring for that patient. The Care-team shown to the patient will automatically be updated when new care providers come on duty. The screen indicates that they are in the hospital. The role of each Care-team member is specified so the patient knows, e.g., if a care provider is a doctor (and whether the doctor is a resident or attending physician), a medical student, or a nurse as shown in FIG. 2.

In one exemplary embodiment, messages from care providers to the patient are color coded to indicate the role of the care provider as shown by way of example in FIG. 6.

Each Care-team member specifies whether he or she is on and off duty at the beginning or end of their shift. Off duty Care-team members will not appear on the patient's screen so patients can only communicate with care providers on duty.

Medical Conditions

Care providers can store information on the system relating to medical conditions being treated for each patient. Patients can view this information on their client devices as shown, e.g., in FIG. 3. A patient can see what active conditions his or her Care-team is treating. In one exemplary embodiment, the default setting is only the active conditions. However, patients can also choose to see all their medical diagnoses, if desired, by filtering the list of medical conditions from “active” to “all.” The entire list of medical conditions for a patient can be imported into the application on the client device using, e.g., the Continuity of Care Documents standards (CCD), which is an XML-based standard.

Treatment/Goals

The nurse or doctor can enter information on the treatment being provided and goals for each patient. The information can be shown to the patient, e.g., in the screenshot of FIG. 3. The information can be organized as a flat list or by the medical condition. For example, a goal for a patient who has a rib fracture may be to use the incentive spirometer three times a day. The treatment for pneumonia may be antibiotics. In this way, the patient is informed of how his or her medical condition is being treated and how the patient can be engaged to improve healing and recovery. Risks of treatment or treatment strategies may also be conveyed to help the patient choose the appropriate treatment based on their preferences.

Schedule

Patients can view lab and imaging tests that were ordered as well as scheduled procedures as shown in FIG. 4. These can be sorted by date and time so that patients know when to expect them. The doctor or nurse can also update the patient with a time they will be in to see the patient. This allows patients to schedule their day so they do not feel like they are waiting long periods of time for the doctor or nurse to arrive.

Care-team Patient/Task and Alert Manager

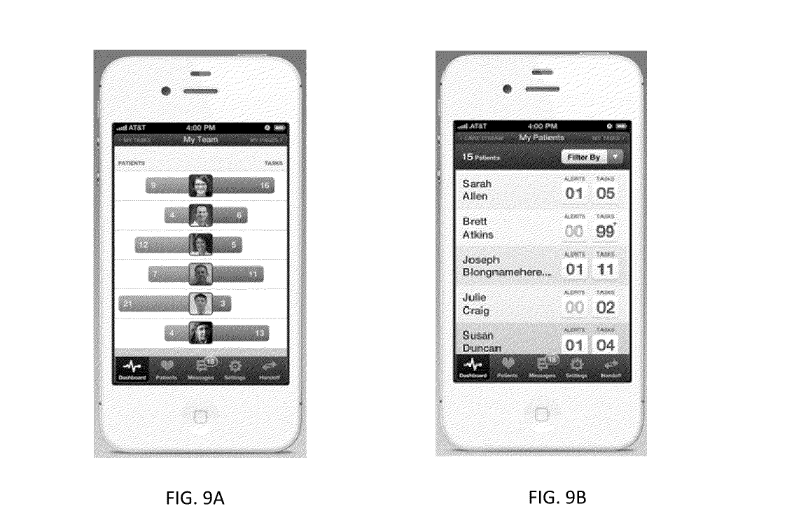

In accordance with one or more further embodiments, the system includes a patient/task and alert manager that enables members of a Care-team within the hospital (e.g., Cardiology Team) to view a summarization of tasks, alerts, and patients for the Care-team. The number of tasks and patients can be displayed graphically for each care provider under the “My Team” tab as shown in the example screenshot of FIG. 9A. Under a “My Patients” tab, the number of tasks and alerts for each patient of a given Care-team member can be viewed as shown in FIG. 9B. The system summarizes tasks for a Care-team and alerts in real-time for patients admitted to the hospital. This feature allows the Care-team to coordinate and distribute tasks for a patient in a manner that creates transparency, does not overburden one team member, and allows important alerts to be known by the entire team. This screen is visible to all Care-team members, including the attending in charge, so details of patient care are clear and no Care-team member is left in the dark about expected tasks to be completed. The real-time management of tasks using the application allows the Care-team to see how efficiently they are working and allow them to redistribute their efforts if needed to ensure care is timely delivered. Detailed analytics of Care-team processes are captured to allow analysis of response times for Care-team communication, alerts, tasks, and consults.

Care-Stream/Patient Wall

In accordance with one or more further embodiments, the system allows all communication to be captured both for a Care-team and for a patient.

The system features a “wall” that can be used to share images, alerts, tasks, consult requests, text messages, and status updates for a patient while the patient is in the hospital.

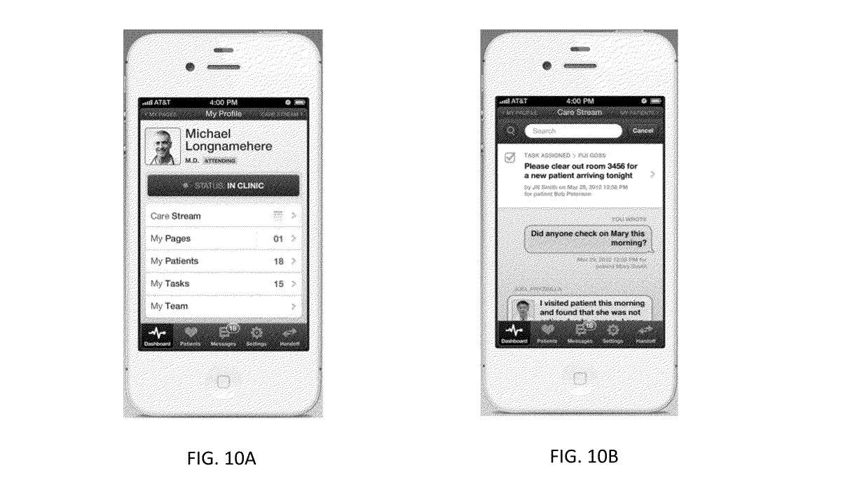

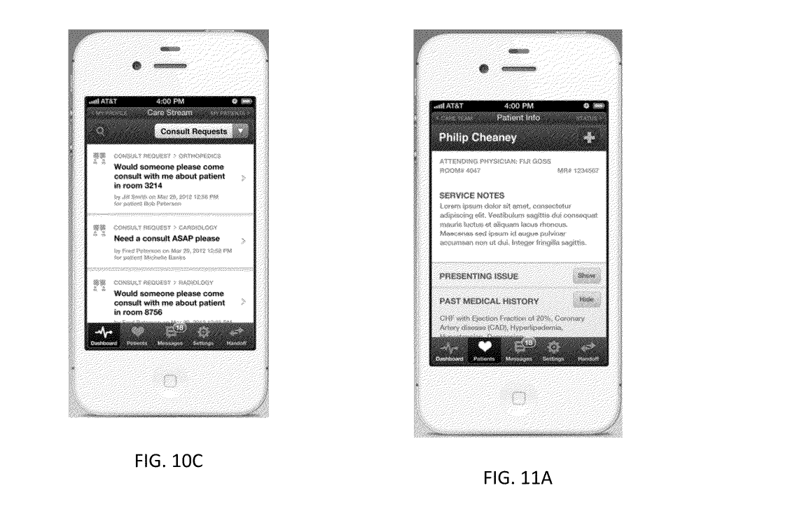

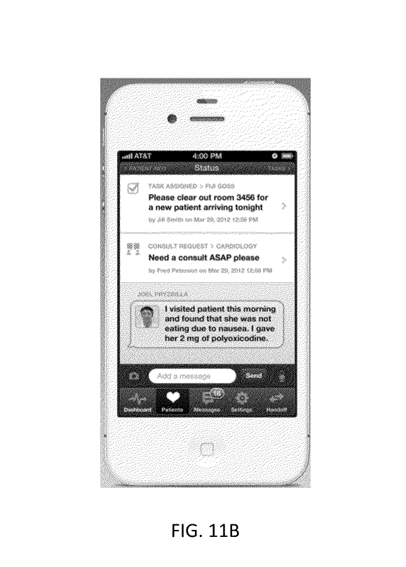

The “Care-stream” summarizes all communication for a Care-team across all patients they are caring for which can be filtered to only summarizes communication between Care-team members for a specific patient. In this way, the Care-team is kept on the “same page” and communication is transparent between the Care-team for all their patients as well as the individual patient. The Care-stream is accessible from a dashboard (shown by way of example in FIG. 10A) and selecting this will allow the user to view all the Care-team communication as shown in FIG. 10B. Users can also filter this stream by the type communication as shown in FIG. 10C (e.g., Consult).

If the user wants to only see communication about a specific patient, they have two options. They can select “My Patients” from the Dashboard and then swipe to patient “Status” or they can select “Patients” from the bottom of their screen, select the patient and then go to the patient status screen. This allows the user to view the patient's wall, which shows the communication, tasks, alerts, consult requests, and status updates for that specific patient. To ensure Care-teams are familiar with the patient's medical conditions while communicating, the patient's medical history can be viewed as shown in FIG. 11A. A status screen for the patient is shown in FIG. 11B, which summarizes all Care-team communication for that patient.

The processes of the information, communication, and collaboration system described above may be implemented in software, hardware, firmware, or any combination thereof. The processes are preferably implemented in one or more computer programs executing on a programmable computer (which can be part of the server computer system) including a processor, a storage medium readable by the processor (including, e.g., volatile and non-volatile memory and/or storage elements), and input and output devices. Each computer program can be a set of instructions (program code) in a code module resident in the random access memory of the computer. Until required by the computer, the set of instructions may be stored in another computer memory (e.g., in a hard disk drive, or in a removable memory such as an optical disk, external hard drive, memory card, or flash drive) or stored on another computer system and downloaded via the Internet or other network.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments.

Additionally, elements and components described herein may be further divided into additional components or joined together to form fewer components for performing the same functions. For example, the computer server system may comprise one or more physical machines, or virtual machines running on one or more physical machines. In addition, the computer server system may comprise a cluster of computers or numerous distributed computers that are connected by the Internet or another network.

Accordingly, the foregoing description and attached drawings are by way of example only, and are not intended to be limiting.

What is claimed is:

1. A computer-implemented method for facilitating information sharing, communication, and collaboration in a healthcare facility, the method comprising:
maintaining data in a computer storage system relating to each of a plurality of patients being treated at the healthcare facility, said data for each patient including (a) information relating to medical care being provided to the patient in the healthcare facility, and (b) information relating to a team of healthcare providers at the healthcare facility assigned to the patient;
providing access to the data relating to each patient to the patient and the team of healthcare providers assigned to the patient by transmitting information to client computer devices operated by the patient and the team of healthcare providers at the healthcare facility;
exchanging messages among patients and healthcare providers through their respective client computer devices; and
enabling each team of healthcare providers to coordinate and distribute tasks relating to the medical care provided to each patient.

2. The method of claim 1, wherein the client computer devices operated by the patients and healthcare providers comprise desktop computers, notebook computers, tablet computers, or smart phones.

3. The method of claim 1, wherein the information relating to medical care being provided to the patient comprises information on a medical condition, a treatment goal, a test result, a scheduled test, or a message.

4. The method of claim 1, wherein the information relating to medical care being provided to the patient indicates when a given healthcare provider will visit the patient.

5. The method of claim 1, wherein messages from healthcare providers to patients comprises text messages, images, video, or recorded audio messages.

6. The method of claim 1, wherein information relating to the team of healthcare providers assigned to a patient includes information identifying which members of the healthcare team are currently on-duty at the healthcare facility.

7. The method of claim 1, wherein information relating to the team of healthcare providers assigned to a patient includes information on a role of each member of the team.

8. The method of claim 7, wherein messages from healthcare providers to patients are color-coded to indicate the role of the health care provider.

9. The method of claim 1, wherein enabling each team of healthcare providers to coordinate and distribute tasks includes providing the team of healthcare providers with a list of patients assigned to the team and information on tasks or alerts for the patients.

10. The method of claim 1, further comprising providing access to health care providers to a patient wall for each patient to share information about the patient.

11. The method of claim 10, wherein the patient wall is used by the healthcare providers to post images, alerts, tasks, consult requests, text messages, and status update for the patient.

12. The method of claim 1 further comprising providing a summary of communication for members of a healthcare team across all patients assigned to the team.

13. A computer system, comprising:
at least one processor;
memory associated with the at least one processor; and
a program supported in the memory for facilitating information sharing, communication, and collaboration in a healthcare facility, the program containing a plurality of instructions which, when executed by the at least one processor, cause the at least one processor to:
(a) maintain data in a computer storage system relating to each of a plurality of patients being treated at the healthcare facility, said data for each patient including (a) information relating to medical care being provided to the patient in the healthcare facility, and (b) information relating to a team of healthcare providers at the healthcare facility assigned to the patient;
(b) provide access to the data relating to each patient to the patient and the team of healthcare providers assigned to the patient by transmitting information to client computer devices operated by the patient and the team of healthcare providers at the healthcare facility;
(c) exchange messages among patients and healthcare providers through their respective client computer devices; and
(d) enable each team of healthcare providers to coordinate and distribute tasks relating to the medical care provided to each patient.

14. The system of claim 13, wherein the client computer devices operated by the patients and healthcare providers comprise desktop computers, notebook computers, tablet computers, or smart phones.

15. The system of claim 13, wherein the information relating to medical care being provided to the patient comprises information on a medical condition, a treatment goal, a test result, a scheduled test, or a message.

16. The system of claim 13, wherein the information relating to medical care being provided to the patient indicates when a given healthcare provider will visit the patient.

17. The system of claim 13, wherein messages from healthcare providers to patients comprises text messages, images, video, or recorded audio messages.

18. The system of claim 13, wherein information relating to the team of healthcare providers assigned to a patient includes information identifying which members of the healthcare team are currently on-duty at the healthcare facility.

19. The system of claim 13, wherein information relating to the team of healthcare providers assigned to a patient includes information on a role of each member of the team.

20. The system of claim 19, wherein messages from healthcare providers to patients are color-coded to indicate the role of the health care provider.

21. The system of claim 13, wherein enabling each team of healthcare providers to coordinate and distribute tasks includes providing the team of healthcare providers with a list of patients assigned to the team and information on tasks or alerts for the patients.

22. The system of claim 13, wherein the program further comprises instructions for providing access to health care providers to a patient wall for each patient to share information about the patient.

23. The system of claim 13, wherein the patient wall is used by the healthcare providers to post images, alerts, tasks, consult requests, text messages, and status update for the patient.

24. The system of claim 13 wherein the program further comprises instructions for providing a summary of communication for members of a healthcare team across all patients assigned to the team.
